(19) United States
(12) Patent Application Publication
(10) Pub. No.: US 2017/0238282 A1
(43) Pub. Date: Aug. 17, 2017

(54) A MECHANISM OF RESOURCE-POOL MONITORING FOR INTER-CELL DEVICE-TO-DEVICE COMMUNICATION

(71) Applicant: Sharp Kabushiki Kaisha, Sakai City, Osaka (JP)

(72) Inventor: Xusheng WEI, Staines (GB)

(21) Appl. No.: 15/501,883

(22) PCT Filed: Aug. 6, 2015
(86) PCT No.: PCT/JP2015/003956

§ 371 Date: Feb. 6, 2017

Related U.S. Application Data
(60) Provisional application No. 62/034,850, filed on Aug. 8, 2014.

(51) Int. Cl. H04W 72/04

(52) U.S. Cl. CPC H04W 72/04; H04W 92/18

(57) ABSTRACT

A method performed by a user equipment (UE) is provided. The method includes receiving a configuration information to configure resource pools of neighbor cells and monitoring a number of the resource pools for inter-cell device-to-device (D2D) communication. The number of the resource pools is limited to a value. A method performed by an evolved NodeB (eNodeB) is also provided. The method includes broadcasting a configuration information to configure resource pools of neighbor cells.

### TECHNICAL FIELD

The present invention relates to resource-pool monitoring configurations used in inter-cell device-to-device (D2D) communication. The present invention also relates to resource-pool monitoring configurations which can be used in discovery and/or communications operations.

### BACKGROUND ART

D2D communication is one of the key features of the 3rd Generation Partnership Project (3GPP), Release 12. Introducing D2D communication improves spectrum efficiency and overall throughput, reduces a terminal's power consumption, and enables new peer-to-peer services. Typical applications include, but are not limited to, public safety, network offloading, etc. However, because D2D transmission utilizes the uplink bandwidth of a terminal, assuming a UE has only one RF chain, a D2D receiver is unable to perform either of: (a) simultaneous D2D transmission and D2D reception, or (b) simultaneous LTE and D2D reception. Note that, D2D communications will take place over the uplink such that it is possible for the UE to perform simultaneous D2D transmission and LTE transmission.

In a D2D communication scenario, two modes are defined in 3GPP TR 36.843 v 12.0.1. From a transmitting perspective of a User Equipment (UE), a UE can operate in two modes for resource allocation:

Mode 1: an Evolved Node B (eNodeB) or Release-10 relay node schedules the exact resources used by a UE to transmit direct data and direct control information.

Mode 2: a UE on its own selects resources from resource pools to transmit direct data and direct control information.

For Mode 1: the location of the resources for transmission of the scheduling assignment by the broadcasting UE comes from the eNodeB; and the location of the resource(s) used in the transmission of the D2D data by the broadcasting UE comes from the eNodeB. For Mode 2: a resource pool used for scheduling assignments is pre-configured and/or is semi-statically allocated (i.e., the resource pool used for scheduling assignments could be changed slowly over time); and the UE selects on its own resource from the resource pool for scheduling assignment to transmit as its scheduling assignment.

When using Mode 2, the UE will select the transmission resource from a resource pool automatically. Accordingly, it is possible that different UEs will select a same frequency/time resource for transmission. Thus, as compared with Mode 2, one advantage of Mode 1 is that Mode 1 will avoid such a possible collision caused by different UEs selecting a same frequency/time resource for transmission because the transmission resources are allocated by the eNodeB which has much more information regarding the usage of frequency/time resources than the UEs would.

Mode 2 is usually used for out-of-coverage scenario or for when a UE is in an idle state. For in-coverage scenarios, the latest agreements are discussed in the Report of 3GPP TSG RAN WG2 meeting #86. The eNodeB may configure a UE to be in a RRC_CONNECTED state by dedicated signaling with a Mode 2 resource allocation transmission resource pool that may be used without constraints while the UE is in the RRC_CONNECTED state. Alternatively, the eNodeB may configure a UE to be in a RRC_CONNECTED state by dedicated signaling with a Mode 2 resource allocation transmission resource pool in which the UE is allowed to select its own resources from resource pools being permitted only in exceptional cases with the UE being otherwise maintained in Mode 1.

In Mode 1, a Scheduling Assignment (SA) resource pool will be configured and a UE which is intended to have D2D reception will monitor the SA resource pool. The SA resource pool could be semi-static or pre-configured. Within a SA resource pool, one or more resource patterns for transmission (RPTs) of time and/or frequency resources for multiple transmission opportunities of data transmission blocks (TBs) can be defined.

### SUMMARY OF INVENTION

### Technical Problem

However, the above schemes do not take into account the amount of effort a UE must undertake to continue monitoring the SA resource pools or Mode 2 resource pools that are allocated by other cells. There are many instances in which a UE may, in following the above-described configurations, may be wasting resources by monitoring a large number of SA resource pools or Mode 2 resource pools, in some scenarios these monitored pools will even be irrelevant to the D2D communications of the UE. Thus, the question of how to efficiently and effectively monitor SA resource pools or Mode 2 resource pools in a manner which will still permit D2D communication, but which will also not result in an inefficient use of the power and bandwidth of the UE is still unanswered.

### Solution to Problem

According to the present invention, there is provided a method performed by a user equipment (UE) comprising:

receive a configuration information to configure resource pools of neighbor cells; and monitor a number of the resource pools for inter-cell device-to-device (D2D) communication, wherein the number of the resource pools is limited to a value.

According to the present invention, there is provided a method performed by an evolved NodeB (eNodeB) comprising:

broadcasting a configuration information to configure resource pools of neighbor cells,

wherein a number of the resource pools for inter-cell device-to-device (D2D) communication is monitored by a user equipment (UE) and the number of the resource pools is limited to a value.

According to the present invention, there is provided a user equipment (UE) comprising:

a receiving circuitry configured to/programmable to receive a configuration information to configure resource pools of neighbor cells; and

monitor a number of the resource pools for inter-cell device-to-device (D2D) communication, wherein the number of the resource pools is limited to a value.

According to the present invention, there is provided a evolved NodeB (eNodeB) comprising:

a transmission circuitry configured to/programmable to broadcast a configuration information to configure resource pools of neighbor cells,

wherein a number of the resource pools for inter-cell device-to-device (D2D) communication is monitored by a user equipment (UE) and the number of the resource pools is limited to a value.

### Advantageous Effects of Invention

To overcome the problems described above, preferred embodiments of the present invention provide resource-pool monitoring configurations which are usable in inter-cell D2D communication. The preferred embodiments of the present invention provide multiple resource-pool monitoring configurations which improve power efficiency and system efficiency of UE used in D2D communication.

The above and other features, elements, characteristics, steps, and advantages of the present invention will become more apparent from the following detailed description of preferred embodiments of the present invention with reference to the attached drawings.

### BRIEF DESCRIPTION OF DRAWINGS

FIG. 1 is an illustration of an example of inter-cell D2D communication performed in accordance with a preferred embodiment of the present invention.

FIG. 2 is a flow chart which explains a UE-based resource pool monitoring selection method in accordance with a preferred embodiment of the present invention.

FIG. 3 is a diagram showing resource pools of three example cells in accordance with a preferred embodiment of the present invention.

FIG. 4 is a block diagram of a UE in accordance with preferred embodiments of the present invention.

FIG. 5 is a block diagram of an eNodeB in accordance with preferred embodiments of the present invention.

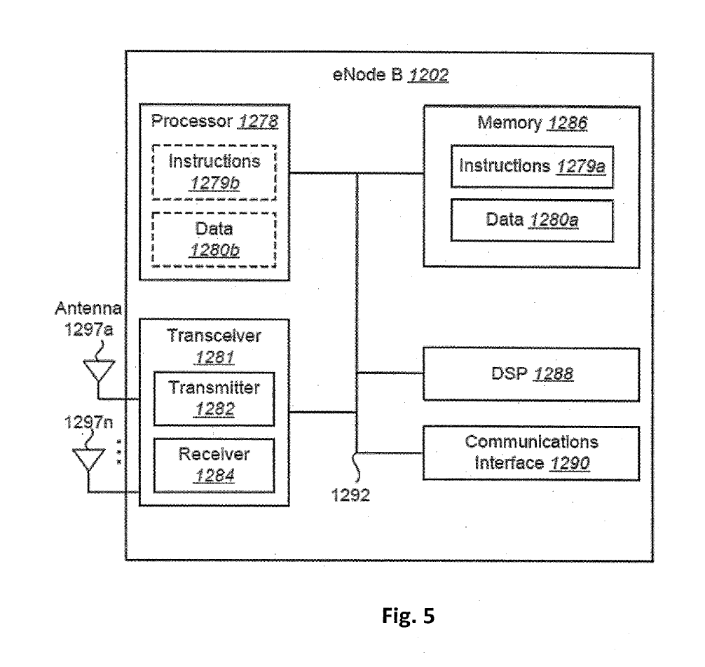

### DESCRIPTION OF EMBODIMENTS

### Example 1

As discussed above, in D2D communications, two modes are defined in 3GPP TR 36.843 v 12.0.1. First, a UE can operate in Mode 1: a mode in which an eNodeB or Release-10 relay node schedules the exact resources used by a UE to transmit direct data and direct control information. Second, a UE can operate in Mode 2: a mode in which a UE selects resources from resource pools to transmit direct data and direct control information on its own. In the following description, the use of the term “resource pool” refers to both a SA resource pool and a resource pool used in Mode 2.

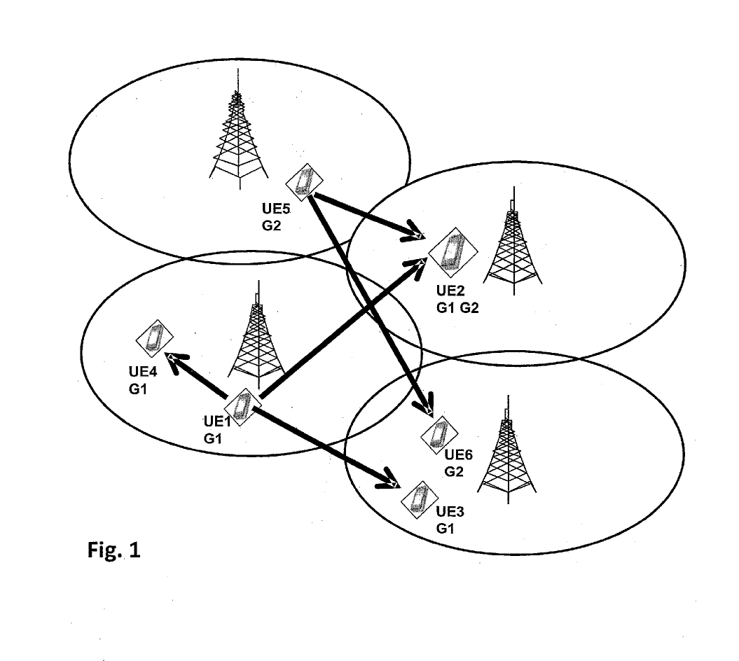

In inter-cell D2D communications, a D2D receiver not only monitors the resource pool of its serving cell, but it must also monitor the resource pool being allocated by other cells that the D2D receiver is communication with. Sometimes, the number of resource pools monitored during a D2D reception could become quite high. For example, in an inter-cell D2D communication scenario, it is quite possible that the resource pools monitored by a UE for D2D reception could become quite numerous. In addition to this issue, another particular problem is that a UE may monitor a resource pool even if the resource pool is not even involved in a corresponding D2D operation. For example in FIG. 1, UE 3 which is only interested in D2D group 1 communications (G1 communications) could still be monitoring resource pool configurations for UE 5, which is only being used for D2D group 2 communication (G2 communications). Under this scenario, UE 3 spends extra effort in monitoring the particular resource pool of UE 5, even though this monitoring of UE 5 does not provide any benefit to D2D operation of the G1 communication. In the example depicted in FIG. 1, UE1, UE2, UE3, and UE4 are all involved in the G1 communication while all of UE2, UE5, and UE6 are involved in the G2 communication. Thus, the only UE which should be monitoring all resource pools of the other UEs is UE2, which is involved in both the G1 and G2 communications.

There are numerous problems which are caused by monitoring a large number of resource pools. For example, UE battery power consumption is increased for every resource pool which is being monitored. Accordingly, having a UE monitor a particular resource pool which is not required for a specific D2D communication performed by the UE results in expending battery power without providing any benefit to the UE. Further, when a UE is monitoring a resource pool, a UE will retune one of its RF chains from downlink to uplink Thus, for a UE with only a single available RF chain (i.e., a UE which does not have the capability to simultaneously receive D2D at uplink and WAN at downlink), the UE will be prohibited from having WAN downlink reception during that period because its RF filter is being used to pick up the signal at uplink such that it is unavailable to be used for downlink operations. Accordingly, a large monitor zone will result in a D2D UE not having enough resources (both time and frequency domain resources) to get WAN reception such that the throughput of the UE will be reduced. Further, when a large number of UEs which are involved in a single D2D communication have this issue, then the entire system throughput of the single D2D communication will be reduced and each UE will be negatively influenced.

Regarding resource pool configuration/allocation, there are two categories to specifically consider when discussing inter-cell scenarios. The first category is when an eNodeB configures (using any of pre-configured signaling, semi-static signaling, and/or Radio Resource Control (RRC) signaling) its resource pool without any consideration of the resource pool allocation status of other eNodeBs, i.e., a fully uncoordinated case. The advantage of this first category is that each eNodeB can configure its resource pool based on its own situation, for example, the total D2D data load present at the eNodeB. Additionally this method may reduce the amount of Signaling or Administration and Management (A&M) effort since the eNodeB does not consider any coordination between different eNodeBs. Alternatively, the resource pool allocation of one eNodeB could be impacted by the situation of its neighbor eNodeBs, i.e., resource pool allocations between different eNodeBs are coordinated. Through coordination, the resource pools of different eNodeBs can be fully overlapping, fully non-overlapping, or have a common overlapping area.

Regardless of whether resource pool allocation/configuration at a cell specific level is coordinated or not coordinated, if cells are in a fully non-overlapping state, the inter cell D2D reception requires a UE to retrieve resource pool configuration information. Such resource pool configuration information can be obtained by the UE different ways:

1. Through the System Information Block (SIB) signaling of its neighbor cells. However in LTE, a UE is not required to decode the SIB signaling of its neighbor cells.

2. Through a eNodeB broadcasting resource pool configuration status of its neighbor cells. This serving cell can get this information through an A&M mechanism or through X2 interface (however in rel-12 information exchanged over X2 interface will not be considered).

3. A cell edge D2D UE will relay resource pool configuration status of its serving cell to its neighbor cells. However the availability of such information is not fully guaranteed if there is no UE with active D2D operations.

4. Resource pool allocation information could possibly be carried by the Physical D2D synchronization channel (PD2DSCH).

No matter which way is used, the signaling amount and coordination becomes more and more complicated with the increase of the number of D2D resource pools which need to be monitored (during discovery or communication). In addition a UE having D2D reception also requires more and more resource pools to meet the requirements of increased monitoring.

One possible way to reduce the size of resource pool to be monitored per D2D UE is to align resource pools across neighbor cells within the same frequency layer. This method may reduce the signaling amount used to exchange resource pool configuration information for inter cell D2D discovery/communication as well. However one disadvantage of this method is an eNodeB cannot configure resource pools based on its own conditions, for example based on the D2D data load detected by the eNodeB. In an extreme scenario, even if there is a non-D2D capable UE camping on one particular cell, this one particular cell still needs to configure resource pools for D2D operations for the non-D2D capable UE when the common resource pool configuration is fixed.

In accordance with a preferred embodiment of the present invention, it is possible to set an upper limit on a UE monitoring size to overcome the above-described problems. A minimum requirement (upper limit) could be defined based on the number of D2D transmissions to be monitored. For example in LTE communications under a RRC_CONNECTED state, a UE needs to measure 8 intra-frequency cells when no measurement gap is allocated in order to maintain UE mobility. At least in Release 12, D2D communication is a broadcast type communication and mobility maintenance is not as crucial as it is in LTE. Hence a lower value can be used for this upper limit in Release 12. The upper limit could be, for example, the summation of SA resource pools and Mode 2 resource pools. For D2D discovery, a separate upper limit can be set. The value could be fixed in the specifications of the UE or eNodeB.

In addition to that upper limit, an eNodeB can also setup an indicator on the maximum resource pools to be monitored based on its own status such as, for example, the WAN traffic load, D2D traffic load, etc. The indicator could be, for example, cell specific and preferably transmitted by SIB signaling. One particular example is that indicator is included in the D2D SIB signaling as an option field. Alternatively, that indicator could be UE dependent and sent to a particular UE through RRC signaling.

Resource pool monitoring control is also possible in accordance with a preferred embodiment of the present invention. In this control, a UE will obtain resource pool configuration information of neighbor cells, preferably based on one or more of the various ways described above, in order to implement inter-cell D2D reception. As mentioned before, monitoring a very large number of resource pools could damage system performance. Accordingly, one solution which could be used to reduce the damage to system performance would be to reduce the number of resource pools to be monitored based on a determination as to whether a particular resource pool has that terminal's related D2D activities or not. For example, after its synchronization procedure, a D2D UE starts to monitor related resource pools, at the same time as the UE starts to monitor related resource pools, the UE could also start a timer or a counter for each particular resource pool. For a particular resource pool, if that UE detects any related D2D activities (for example, a D2D reception) before the timer/counter expires, then that UE will restart the timer/counter and continue the monitor process of that particular resource pool. However, if the UE does not detect any related D2D activities after the timer/counter expires, then the UE will preferably try to terminate the monitoring process of that particular resource pool or reduce the amount of monitoring time spent on that resource pool. The value of timer/counter can preferably be UE specific and sent from the eNodeB to the UE through RRC signaling, for example. If a UE intends to reduce the monitoring activities on a particular resource pool, it could also start a “monitoring control” procedure which is discussed in greater detail below.

A network based procedure in accordance with a preferred embodiment of the present invention which may be used to realize the “monitoring control” will now be discussed. The UE first sends an indicator through RRC signaling to its serving eNodeB to ask whether the UE is permitted to reduce monitoring activities/terminate monitoring process of a resource pool or not. After the eNodeB get this indicator, the eNodeB will make the decision and send the decision back to corresponding UE, preferably by RRC signaling, for example. When reducing monitoring activities, during one D2D discover/communication period/cycle a UE can monitor the resource pools chosen by the eNodeB less frequently during that period/cycle. In addition, the eNodeB can broadcast corresponding information (e.g., either terminate a monitoring process or reduce monitoring activities) such that all related D2D UEs which are monitoring the same resource pool can take similar actions. For example, the eNodeB can configure (broadcast) Discontinuous Reception (DRX) related parameters per resource pool (or per D2D group if a D2D group can be identified by UE), then all in-coverage UEs monitoring that resource pool can take similar actions by following eNodeB's instruction/configuration.

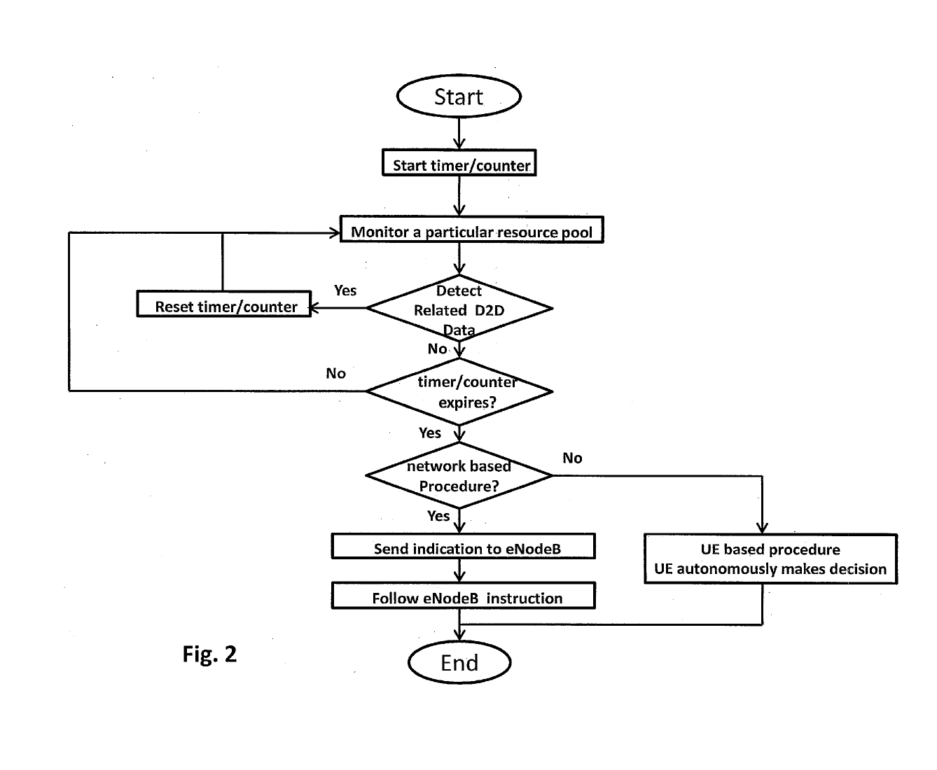

A UE based procedure in accordance with a preferred embodiment of the present invention will now be discussed. It is also possible for a UE autonomously update its monitoring behavior. For example, a UE may preferably start a DRX operation autonomously. This procedure is preferred for a UE which is fully out of coverage since it cannot get any instruction from any eNodeB. A flowchart explaining this preferred embodiment of a method for autonomous UE operation is provided in FIG. 2. After triggering a “monitoring control” process, a UE could restore to its normal monitoring status, i.e., a UE could increase monitoring activities on a particular resource pool or restart its monitoring of a particular resource pool, after related D2D activities are available on that resource pool. A UE can fulfill this task through the “monitoring control restore” procedure as described below:
If a UE detects an increase in related D2D activities on a particular resource pool, similar to the above-described “monitor control” procedure, a UE can send an indicator to eNodeB and then follow the instructions which are sent back from the eNodeB to the UE through, for example, RRC signaling. In addition, the eNodeB can also broadcast a corresponding decision (for example, a decision to restore monitoring control) such that all related D2D UEs can take similar actions.
For UEs which terminate monitoring activities on a particular resource pool, the UEs can follow broadcast information from eNodeB to restore to original monitoring status.

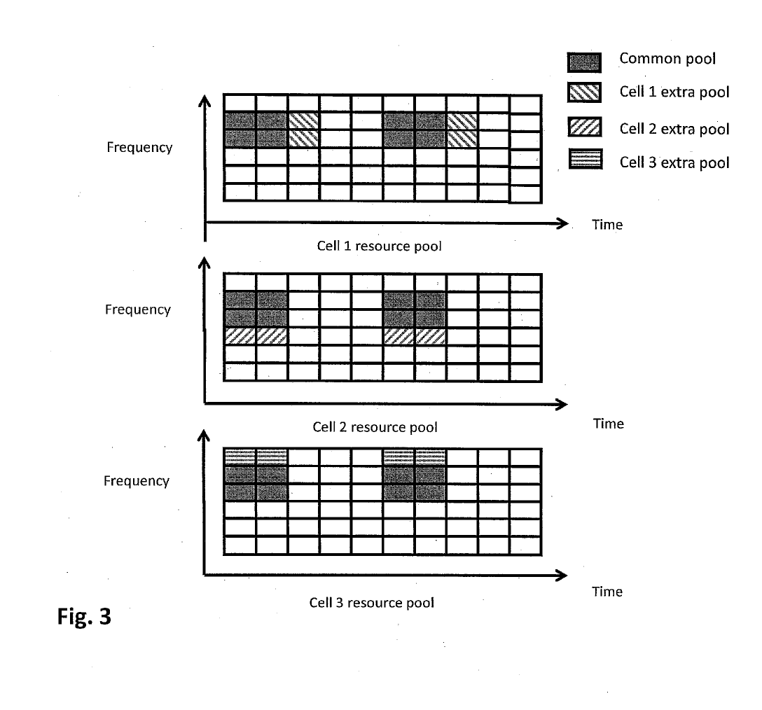

Coordination on an eNodeB resource pool configuration in accordance with a preferred embodiment of the present invention will now be discussed. As mentioned before, one disadvantage of using fully overlapping resource pools across different cells within one frequency layer is the limitation on the flexibility of resource pool configuration/allocation. A compromise design developed according to a preferred embodiment of the present invention is to ensure a common overlapping pool across different cells within one frequency layer such that each cell still can configure/allocate extra resource pools. Within each cell, the common resource pool and extra resource pool can either be treated as just one resource pool or be treated as different resource pools. For example, the resource pools of three example cells (Cell 1, Cell 2, and Cell 3) are shown in FIG. 3. Each of these three resource pools of Cell 1, Cell 2, and Cell 3 include resources which overlap in the time domain and frequency domain, these resources which overlap in the time domain and frequency domain are referred to as the “common” pool. Cell 1, Cell 2, and Cell 3 also include additional respective resources which are arranged at positions which do not overlap in the time domain and frequency domain which are referred to as the “extra” pool. The “extra” pool is an independent resource pool and is not shared by different cells. Thus, the “common” pools and the “extra” pools of Cell 1, Cell 2, and Cell 3 together define the respective resource pools of Cell 1, Cell 2, and Cell 3 and include shared resources referred to as a “common” pool and unshared resources referred to as an “extra” pool. Note that is it also possible to a cell to have resources only in a “common” pool or only in an “extra” pool.

When treated as different resource pools, the following techniques can be considered to optimize D2D operation:

1. D2D transmission in the common overlapping space will not interfere with WAN transmission of other cells. Hence D2D transmission with a higher power level could be allocated to this zone to avoid severe/undesirable interference on WAN transmission of other cells.

2. D2D transmission allocated to the common space could be based on priority.

In accordance with the above, the common space could be pre-configured or predefined in the specifications of the UE and/or the eNodeB. If a pre-configured method is used, corresponding parameters could preferably be included, for example, in SIB signaling. The parameters which could be included in the SIB signaling include:

i. frequency domain: bandwidth of the common space; location of the common space within the bandwidth of corresponding frequency layer

ii. time domain: duration of the common space (number of sub-frames); location of the common space for example the location of the common space within a D2D discovery/communication period/cycle.

Thus, the above preferred embodiments of the present invention provide solutions for the numerous problems which are caused by monitoring a large number of resource pools. Using these solutions improve the power efficiency of a D2D UE and also improve the system efficiency. Some of these solutions can be summarized as, for example, providing:
1. an upper bound on a UE monitoring size—the upper bound can be fixed; an additional bound can be configured by eNodeB and broadcast through SIB
2. a UE based resource pool monitoring selection where:
   2.1 a UE detects a resource pool (SA resource pool or resource pool for Mode 2) and checks whether there is any related D2D activities before a corresponding timer/counter expires.
   2.2 The value of timer/counter can be UE specific and sent from eNodeB to UE through RRC signaling.
   2.3 The UE sends an indicator to the eNodeB and the eNodeB decides whether that UE can stop monitoring a particular resource pool or can monitor that particular resource pool less frequently.
3. A common overlapping area defined across different cells within one frequency layer.

FIG. 3 illustrates various components that can be used in a UE 1104 in accordance with preferred embodiments of the present invention. UE 1104 preferably includes a processor 1154 that is configured and programmed to control an operation of the UE 1104. The processor 1154 can also be referred to as a CPU or other similar device. Memory 1174, which can include read-only memory (ROM), random access memory (RAM), or any other device that can be used to store information, provides instructions 1156a and data 1158a to the processor 1154. Memory 1174 can also include non-volatile random access memory (NVRAM). Instructions 1156b and data 1158b can be used by the processor 1154. Instructions 1156b and/or data 1158b loaded into the processor 1154 can also include instructions 1156a and/or data 1158a from memory 1174 that were loaded for execution or processing by the processor 1154. The instructions 1156b can be executed by the processor 1154 to implement the systems and methods disclosed in this specification.

UE 1104 can also include a housing that contains a transmitter 1172 and a receiver 1173 which are configured to allow transmission and reception of data. The transmitter 1172 and receiver 1173 can be combined into a transceiver 1171. One or more antennas 1199a-n are preferably attached to or enclosed within the housing and electrically coupled to the transceiver 1171.

The various components of UE 1104 are preferably coupled together by a bus system 1177, which can include a power bus, a control signal bus, and a status signal bus, in addition to a data bus. However, for the sake of clarity, the various buses are illustrated in FIG. 3 as the bus system 1177. UE 1104 can also include a digital signal processor (DSP) 1175 configured and programmed to be used in processing signals. UE 1104 can also include a communications interface 1176 that provides user access to the functions of UE 1104. UE 1104 illustrated in FIG. 3 is a functional block diagram rather than a listing of specific components.

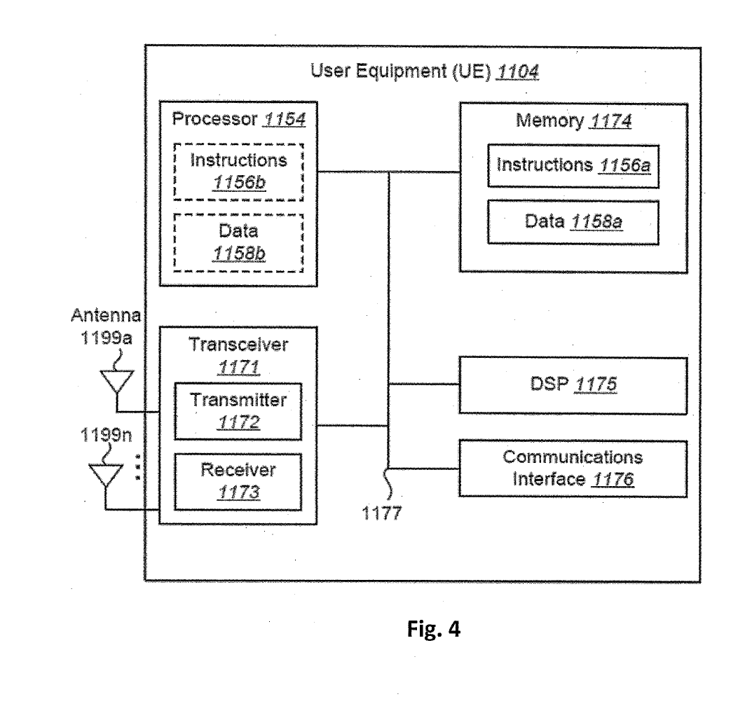

FIG. 4 illustrates various components that can be utilized in an eNodeB 1202 according to preferred embodiments of the present invention. The eNodeB 1202 can include components that are similar to the components discussed above in relation to UE 1104, including a processor 1278, memory 1286 that is configured and programmed to provide instructions 1279a and data 1280a to the processor 1278, instructions 1279b and data 1280b that can reside in or be loaded into the processor 1278, a housing that contains a transmitter 1282 and a receiver 1284 (which can be combined into a transceiver 1281), one or more antennas 1297a-n electrically coupled to the transceiver 1281, a bus system 1292, a DSP 1288 for use in processing signals, a communications interface 1290 and so forth.

Unless otherwise noted, the use of ‘/’ above represents the phrase “and/or.”

The functions described in this specification can be implemented in hardware, software, firmware, or any combination thereof. If implemented in software, the functions can be stored as one or more instructions on a computer-readable medium. The term “computer-readable medium” refers to any available tangible, non-transitory medium that can be accessed by a computer or a processor. By way of example, and not limitation, a computer-readable or processor-readable medium can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or processor. Disk and disc, as used in this specification, includes compact disc (CD), laser disc, optical disc, digital versatile disc (DVD), floppy disk and Blu-ray(Registered trademark) disc, where disks usually reproduce data magnetically, while discs reproduce data optically with lasers. If implemented in hardware, the functions described in this specification can be implemented in and/or realized using a chipset, an application-specific integrated circuit (ASIC), a large-scale integrated circuit (LSI), an integrated circuit, etc.

Each of the methods disclosed in this specification comprises one or more steps or actions for achieving the described method. The method steps and/or actions can be interchanged with one another and/or combined into a single step without departing from the scope of the present invention. In other words, unless a specific order of steps or actions is required for proper operation of the method that is being described, the order and/or use of specific steps and/or actions can be modified without departing from the scope of the claims.

The term “processor” should be interpreted broadly to encompass a general purpose processor, a central processing unit (CPU), a microprocessor, a digital signal processor (DSP), a controller, a microcontroller, a state machine and so forth. Under some circumstances, a “processor” can refer to an application specific integrated circuit (ASIC), a programmable logic device (PLD), a field programmable gate array (FPGA), etc. The term “processor” can refer to a combination of processing devices, e.g., a combination of a DSP and a microprocessor, a plurality of microprocessors, one or more microprocessors in conjunction with a DSP core or any other such configuration.

The term “memory” should be interpreted broadly to encompass any electronic component capable of storing electronic information. The term “memory” can refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory can be integral with a processor and still be said to be in electronic communication with the processor.

The terms “instructions” and “code” should be interpreted broadly to include any type of computer-readable statement(s). For example, the terms “instructions” and “code” can refer to one or more programs, routines, sub-routines, functions, procedures, etc. “Instructions” and “code” can comprise a single computer-readable statement or many computer-readable statements.

It should be understood that the foregoing description is only illustrative of preferred embodiments of the present invention. Various alternatives and modifications can be devised by those skilled in the art without departing from the present invention. Accordingly, the present invention is intended to embrace all such alternatives, modifications, and variances that fall within the scope of the foregoing description.

1. A method performed by a user equipment (UE) comprising:
receive a configuration information to configure resource pools of neighbor cells; and
monitor a number of the resource pools for inter-cell device-to-device (D2D) communication, wherein the number of the resource pools is limited to a value.

2. A method performed by an evolved NodeB (eNodeB) comprising:
broadcasting a configuration information to configure resource pools of neighbor cells,
wherein a number of the resource pools for inter-cell device-to-device (D2D) communication is monitored by a user equipment (UE) and the number of the resource pools is limited to a value.

3. A user equipment (UE) comprising:
a receiving circuitry configured to/programmable to receive a configuration information to configure resource pools of neighbor cells; and
monitor a number of the resource pools for inter-cell device-to-device (D2D) communication, wherein the number of the resource pools is limited to a value.

4. An evolved NodeB (eNodeB) comprising:
a transmission circuitry configured to/programmable to broadcast a configuration information to configure resource pools of neighbor cells,
wherein a number of the resource pools for inter-cell device-to-device (D2D) communication is monitored by a user equipment (UE) and the number of the resource pools is limited to a value.
